(19) United States
(12) Patent Application Publication
(10) Pub. No.: US 2006/0085165 A1
(43) Pub. Date: Apr. 20, 2006

(54) Method for determining a failure of a manufacturing condition, system for determining a failure of a manufacuring condition and method for manufacturing an industrial product

(76) Inventors: Yukihiro Ushiku, Yokohama-shi (JP); Tomomi Ino, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/236,719

(22) Filed: Sep. 28, 2005

(30) Foreign Application Priority Data
Sep. 30, 2004 (JP) P2004-287948

(51) Int. Cl. G06F 11/30

(52) U.S. Cl. 702/183

(57) ABSTRACT

A method for determining a failure of a manufacturing condition, includes creating waveforms implemented by respective first data strings of first characteristic variables corresponding to operation parameter data of manufacturing apparatuses which execute manufacturing processes of products under respective manufacturing conditions for the products; classifying the first data strings that are analogous to each other into groups based on a correlation of the waveforms; creating a first visualized data table visualizing magnitude correlations between the first characteristic variables for each of the groups; adding second data strings of second characteristic variables to the groups, the second characteristic variables corresponding to workmanship data representing measurement and inspection results of the products; and creating a second visualized data table visualizing magnitude correlations between the second characteristic variables for each of the groups.

### CROSS REFERENCE TO RELATED APPLICATIONS AND INCORPORATION BY REFERENCE

This application is based upon and claims the benefit of priority from prior Japanese Patent Application P2004-287948 filed on Sep. 30, 2004; the entire contents of which are incorporated by reference herein.

### BACKGROUND OF THE INVENTION

1. Field of the Invention

The present invention relates to a method and a system for determining a failure of a manufacturing condition of a semiconductor device.

2. Description of the Related Art

Along with advances in multifunction semiconductor devices such as a semiconductor integrated circuit, reduction of pattern dimensions and large-scale integration are in constant demand. It is necessary to manufacture such a semiconductor device in a plurality of chip regions on a semiconductor substrate with a uniform performance and a high manufacturing yield.

In a manufacturing method for the semiconductor device, various manufacturing processes are used. In order to improve the manufacturing yield of the semiconductor device, it is necessary to improve a yield rate for each of the manufacturing processes. Therefore, failure determination of manufacturing conditions which affect the yield rate for each of the manufacturing processes is important.

To determine a failure of a manufacturing condition, a correlation analysis of characteristic variable data which represents various operation parameters of manufacturing apparatuses is implemented. Usually, products of the semiconductor device having similar behaviors of characteristic variable data are classified into the same group. The characteristic variable data in each group are superimposed with each other so that the correlation for the characteristic variable data is visually determined. With such a method, characteristic operation parameters of the manufacturing apparatuses in each group can be understood. However, it is difficult to understand a correlation between workmanship of the manufacturing processes evaluated for each group and each operation parameter. Hence, it is difficult to visually determine operation parameters of manufacturing apparatuses which affect product performance.

### SUMMARY OF THE INVENTION

A first aspect of the present invention inheres in a computer implemented method for determining a failure of a manufacturing condition, including creating a plurality of waveforms implemented by respective first data strings of first characteristic variables corresponding to operation parameter data of a plurality of manufacturing apparatuses which execute a plurality of manufacturing processes of a plurality of products under respective manufacturing conditions for the products; classifying the first data strings that are analogous to each other into a plurality of groups based on a correlation of the waveforms; creating a first visualized data table for each of the groups, the first visualized data table visualizing magnitude correlations between the first characteristic variables; adding second data strings of second characteristic variables to the groups, the second characteristic variables corresponding to workmanship data representing measurement and inspection results of the products; and creating a second visualized data table for each of the groups, the second visualized data table visualizing magnitude correlations between the second characteristic variables.

A second aspect of the present invention inheres in system for determining a failure of a manufacturing condition, including a plurality of monitor units configured to acquire operation parameter data of a plurality of manufacturing apparatuses which execute a plurality of manufacturing processes of a plurality of products under respective manufacturing conditions for the products; an inspection tool configured to acquire workmanship data representing measurement and inspection results of the products; a waveform creation module configured to create a plurality of waveforms implemented by first data strings of first characteristic variables corresponding to the operation parameter data for each of the products; a classification module configured to classify the first data strings that are analogous to each other into a plurality of groups based on a correlation of the waveforms; a table creation module configured to create a first visualized data table for each of the groups and a second visualized data table by adding second data strings of second characteristic variables corresponding to the workmanship data to the groups, the first visualized data table visualizing magnitude correlations between the first characteristic variables, the second visualized data table visualizing magnitude correlations between the second characteristic variables; and an internal memory configured to store the operation parameter data, the workmanship data, the first and second data strings, the groups, and the first and second visualized data tables.

A third aspect of the present invention inheres in a method for manufacturing an industrial product, including executing manufacturing processes of a plurality of products under respective manufacturing conditions; acquiring operation parameter data of a plurality of manufacturing apparatuses which execute the manufacturing processes, the operation parameter data corresponding to the manufacturing conditions for the products; creating a plurality of waveforms implemented by first data strings of first characteristic variables corresponding to the operation parameter data for each of the products; classifying the first data strings that are analogous to each other into a plurality of groups based on a correlation of the waveforms; creating a first visualized data table for each of the groups, the first visualized data table visualizing magnitude correlations between the first characteristic variables; acquiring workmanship data representing measurement and inspection results of the products; adding second data strings of second characteristic variables to the groups, the second characteristic variables corresponding to the workmanship data; creating a second visualized data table for each of the groups, the second visualized data table visualizing magnitude correlations between the second characteristic variables; extracting a target group from the groups based on the magnitude correlations between a target second characteristic variable in the second characteristic variables by using the second visualized data table; extracting a target first characteristic variable from the first characteristic variables of the target group based on the magnitude correlations between the first characteristic variables by using the first visualized data table; and executing a target manufacturing process by determining measures for a target manufacturing condition corresponding to the target first characteristic variable.

### BRIEF DESCRIPTION OF THE DRAWINGS

FIG. 1 is a block diagram showing an example of a configuration of a system for determining a failure of a manufacturing condition according to an embodiment of the present invention.

FIG. 2 is a diagram showing examples of first data strings according to the embodiment of the present invention.

FIG. 3 is a diagram showing examples of first data string waveforms according to the embodiment of the present invention.

FIG. 4 is a diagram showing an example of classification of groups according to the embodiment of the present invention.

FIG. 5 is a diagram showing an example of a first visual data table according to the embodiment of the present invention.

FIG. 6 is a diagram showing examples of second data strings according to the embodiment of the present invention.

FIG. 7 is a diagram showing an example of a second visual data table according to the embodiment of the present invention.

FIG. 8 is a flowchart showing an example of a method for determining a failure of a manufacturing condition according to the embodiment of the present invention.

FIG. 9 is a diagram showing another example of a first visual data table according to the embodiment of the present invention.

FIG. 10 is a diagram showing another example of a second visual data table according to the embodiment of the present invention.

FIG. 11 is a diagram showing an example of a first visual data table according to other embodiment of the present invention.

FIG. 12 is a diagram showing an example of a second visual data table according to the other embodiment of the present invention.

FIG. 13 is a diagram showing another example of a first visual data table according to the other embodiment of the present invention.

FIG. 14 is a diagram showing another example of a second visual data table according to the other embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

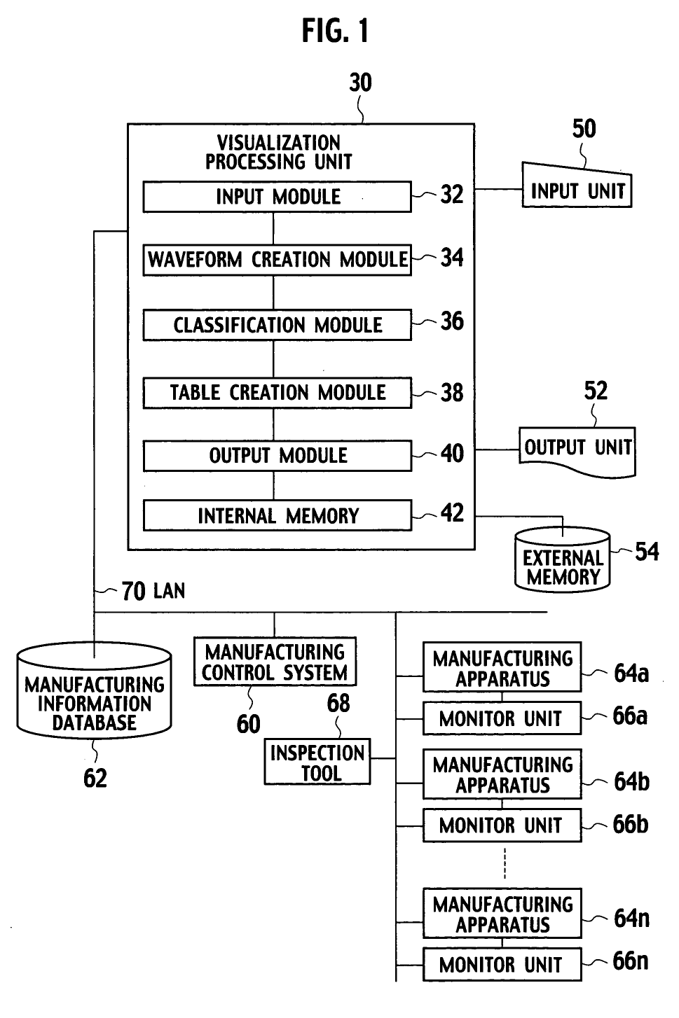

As shown in FIG. 1, a system for determining a failure of a manufacturing condition according to an embodiment of the present invention includes a visualization processing unit 30, an input unit 50, an output unit 52, an external memory 54, a manufacturing control system 60, a manufacturing information database 62, a plurality of manufacturing apparatuses 64a, 64b, 64n, a plurality of monitor units 66a, 66b, . . . , 66n, an inspection tool 68, and the like. Additionally, the visualization processing unit 30 includes an input module 32, a waveform creation module 34, a classification module 36, a table creation module 38, an output module 40, an internal memory 42, and the like.

Manufacturing processes for a plurality of products are executed under respective manufacturing conditions of the manufacturing apparatuses 64a, 64b, . . . , 64n. The visualization processing unit 30 acquires operation parameter data corresponding to the manufacturing conditions. Waveforms of first data strings of first characteristic variables corresponding to the operation parameter data for each of the plurality of products are created. Based on a correlation between the waveforms, the first data strings analogous to each other are classified into groups. A first visualized data table for each of the groups is created. In the first visualized data table, magnitude correlations between the first characteristic variables are visualized by a first graphic pattern. Moreover, workmanship data representing results of measurements and inspections of the plurality of products are acquired. Second data strings of second characteristic variables corresponding to the workmanship data are added to the groups. Thereafter, a second visualized data table for each of the groups is created. In the second visualized data table, magnitude correlations between the second characteristic variables are visualized by a second graphic pattern.

The manufacturing control system 60 and the manufacturing information database 62 are connected to the visualization processing unit 30 through a local area network (LAN) 70. The plurality of manufacturing apparatuses 64a, 64b, . . . , 64n, and the plurality of monitor units 66a, 66b, . . . , 66n provided to the plurality of manufacturing apparatuses 64a, 64b, . . . , 64n, respectively, are connected to the manufacturing control system 60 through the LAN 70.

For example, manufacturing processes for a semiconductor device, as a product, are executed by using the plurality of manufacturing apparatuses 64a, 64b, . . . , 64n under corresponding manufacturing conditions. Various sensors attached to each of the plurality of manufacturing apparatuses 64a, 64b, . . . , 64n monitor operation parameters, during processing, which correspond to the manufacturing conditions. The manufacturing apparatuses 64a, 64b, . . . , 64n include a chemical vapor deposition (CVD) apparatus, a vapor deposition apparatus, a dry etching apparatus, an ion implantation apparatus, a photolithography system and the like. In the case of a CVD apparatus, the sensors include a pressure gauge, a flow meter, a thermometer, a radio frequency (RF) power meter and the like.

The plurality of monitor units 66a, 66b, . . . , 66n provided for the plurality of manufacturing apparatuses 64a, 64b, . . . , 64n, respectively, acquire operation parameter data monitored by the sensors and transmit the operation parameter data to the manufacturing control system 60. The operation parameter data includes, for example, pressure, gas flow rate, temperature, input RF power and the like within a process chamber of a CVD apparatus.

The manufacturing control system 60 collects the operation parameter data transmitted from the plurality of monitor units 66a, 66b, . . . , 66n. The manufacturing control system 60 stores the product numbers of the plurality of products processed by the plurality of manufacturing apparatuses 64a, 64b, . . . , 64n, and the operation parameter data corresponding to each of the products in the manufacturing information database 62.

Additionally, the inspection tool 68 is connected to the manufacturing control system 60 through the LAN 70. The inspection tool 68 acquires workmanship data for each of the products by measuring and inspecting quality control characteristics after completion of each manufacturing process and electrical characteristics after completion of the entire manufacturing processes.

The quality control characteristics of an insulating film or the like deposited by a CVD apparatus, for example, include film thickness, in-plane uniformity, refraction index, the number of particles, deposition rate, and the like. The electrical characteristics of a field-effect transistor (FET), for example, include a threshold voltage, an on-state current, a transconductance, and the like. The manufacturing control system 60 stores the workmanship data, such as the quality control characteristics and the electrical characteristics, measured and inspected by the inspection tool 68, together with the product numbers in the manufacturing information database 62.

From the manufacturing information database 62, the input module 32 of the visualization processing unit 30 acquires the operation parameter data of the plurality of manufacturing apparatuses 64a, 64b, . . . , 64n which have executed the manufacturing processes for the plurality of products. Further, from the manufacturing information database 62, the input module 32 acquires the workmanship data which represents the measurements and inspection results of the plurality of products.

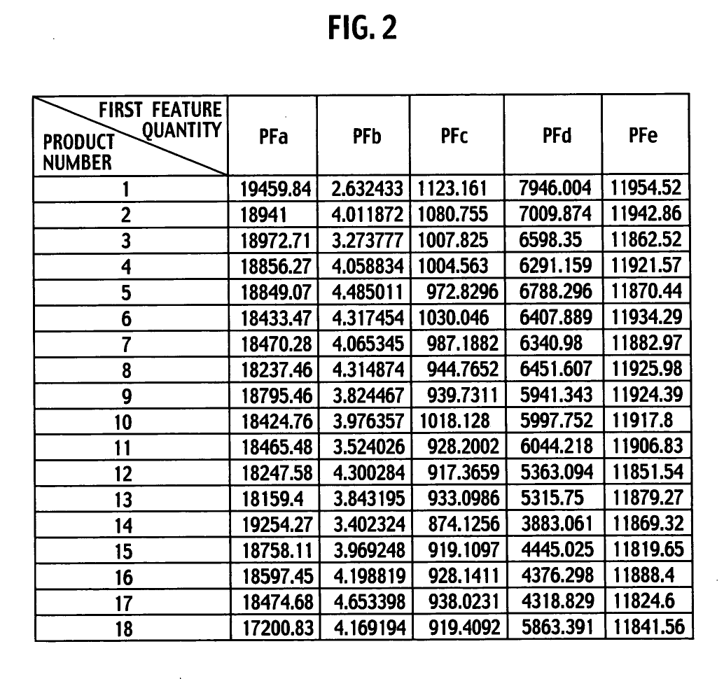

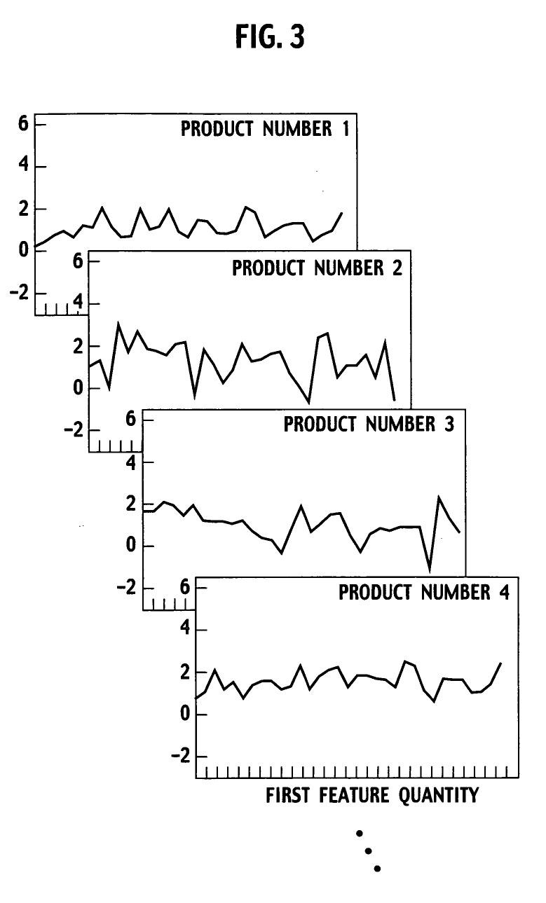

The waveform creation module 34 creates a first data string for each of the product numbers. The first data string has a string of values of a plurality of first characteristic variables corresponding to the operation parameter data of the plurality of manufacturing apparatuses 64a, 64b, . . . , 64n. For example, first characteristic variables PFa, PFb, PFc, PFd, and PFe corresponding to the operation parameter data, such as pressure, gas flow rate, temperature, input RF power and the like of a CVD apparatus, are laid out in a line for each of the product numbers, as shown in FIG. 2. Each of the first characteristic variables PFa, PFb, PFc, PFd, and PFe is calculated, for example, as a deviation from an average value of all of the plurality of products. Furthermore, as shown in FIG. 3, the waveform creation module 34 creates waveforms of the first data strings by depicting the first data string with respect to the plurality of first characteristic variables for each of the plurality of products as a line graph.

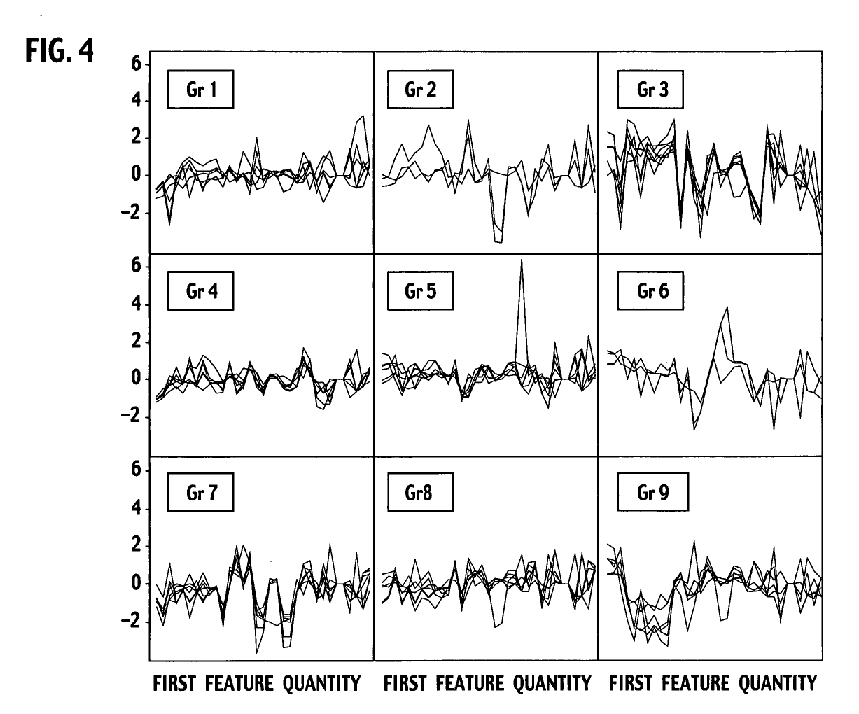

As shown in FIG. 4, the classification module 36 classifies the waveforms of the first data strings that are be analogous to each other based on a correlation between the waveforms of the first data strings of the respective products, into a plurality of groups Gr1 to Gr9. For example, using the created waveforms of the first data strings, a correlation coefficient is calculated for all combinations between the products. The waveforms of the first data strings of the products which have a higher correlation coefficient than a previously specified threshold value, are determined to be analogous to one another. For example, specifying the threshold value of the correlation coefficient to 0.8, the waveforms of the first data strings are classified. Thus, the plurality of products are classified into the plurality of groups Gr1 to Gr9 based on the wavelengths of the first data strings.

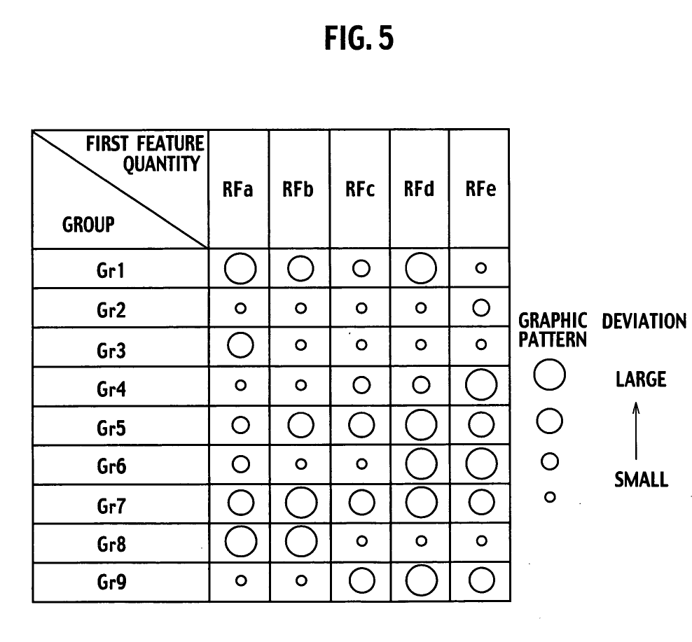

As shown in FIG. 5, the table creation module 38 creates a first visualized data table for indicating the plurality of first characteristic variables PFa, PFb, PFc, PFd, and PFe using graphic patterns, which visualizes magnitude correlations between the plurality of groups Gr1 to Gr9. In the embodiment of the present invention, circles are used as the graphic patterns. Each magnitude of the plurality of first characteristic variables PFa, PFb, PFc, PFd, and PFe is indicated by the size of the circle.

For example, with respect to each of the plurality of first characteristic variables PFa, PFb, PFc, PFd, and PFe, a difference between maximum and minimum values among the average values of deviations in each of the plurality of groups Gr1 to Gr9 is divided into four levels. Different sizes of the circles are assigned respectively to the corresponding magnitudes of the average values of the deviations.

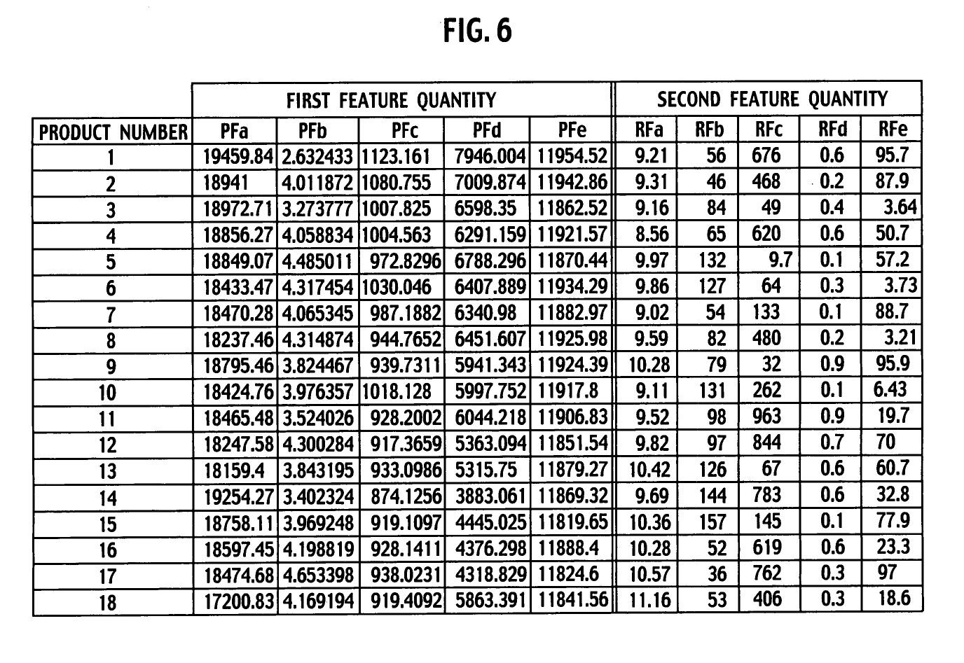

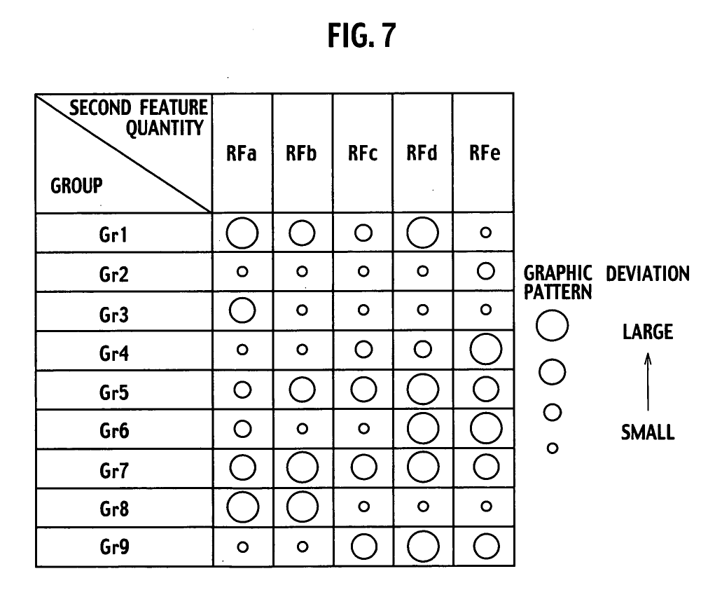

The second data strings having strings of numerical values of a plurality of second characteristic variables corresponding to the workmanship data acquired by the input module 32 are added to the first data strings of the products which are classified into the plurality of groups Gr1 to Gr9, respectively. For example, as shown in FIG. 6, the second characteristic variables RFa, RFb, RFc, RFd, and RFe corresponding to the workmanship data, such as film thickness, in-plane uniformity, refraction index, the number of particles, deposition rate, and the like for the quality control characteristics of CVD, are added to the first data strings. As the second characteristic variables, the workmanship data, such as a threshold voltage, an on-state current, a transconductance, and the like for the electric characteristics of a FET can be used. As shown in FIG. 7, the table creation module 38 creates the second visualized data table where different sizes of the circles are used as graphic patterns to indicate magnitudes of the plurality of second characteristic variables RFa, RFb, RFc, RFd, and RFe in each of the groups Gr1 to Gr9.

For example, with respect to each of the plurality of second characteristic variables RFa, RFb, RFc, RFd, and Rfe, a difference between maximum and minimum values among the average values of deviations in each of the second characteristic variables RFa, RFb, RFc, RFd, and Rfe is divided into four levels in each of the groups Gr1 to Gr9. Different sizes of the circles are assigned respectively to corresponding magnitudes of deviations.

The output module 40 transmits the first and second visualized data tables to the output unit 52 so as to display the first and second visualized data tables. In the first and second visualized data tables, the magnitudes of the first and second characteristic variables PFa, PFb, PFc, PFd, Pfe, and RFa, RFb, RFc, RFd, Rfe are visually indicated by sizes of the graphic patterns, respectively. Therefore, the workmanship data and the operation parameter data of the manufacturing apparatuses can be visually compared to each other in each of the plurality of groups Gr1 to Gr9.

The internal memory 42 stores the operation parameter data and the workmanship data acquired by the input module 32, the first and second data strings and the groups created by the waveform creation module 43 and classification module 36, respectively, the first and second visualized data tables created by the table creation module 38, and the like.

The input unit 50 refers to devices such as a keyboard and a mouse. When an input operation is performed from the input unit 50, corresponding key information is transmitted to the visualization processing unit 30. The output unit 52 refers to a screen monitor, such as a liquid crystal display (LCD), a light emitting diode (LED) panel, an electroluminescent (EL) panel and the like. The output unit 52 displays data tables processed by the visualization processing unit 30 and graphic tables and the like acquired by the same.

The external memory 54 stores a programs which allow the visualization processing unit 30 to implement graphic processing, classification by statistical operations, table creation, and the like, for the acquired data. The internal memory 42 or the external memory 54 of the visualization processing unit 30 temporarily stores data obtained during a calculation and an analysis thereof during the operation of the visualization processing unit 30.

As described above, the system for determining a failure of a manufacturing condition according to the embodiment of the present invention classifies the plurality of products into the plurality of groups Gr1 to Gr9 based on the waveforms of the first data strings created from the operation parameters of the manufacturing apparatuses 64a, 64b, . . . , 64n which execute manufacturing processes of the plurality of products. In each of the plurality of groups Gr1 to Gr9, magnitude correlations between the first and second characteristic variables corresponding to the operation parameters of the manufacturing apparatuses and workmanships of the products, respectively, are visualized by graphic patterns.

Therefore, according to the embodiment of the present invention, a relation between the workmanship of the products and the operation parameters of manufacturing apparatuses 64a, 64b, 64n, which may not be understood heretofore, can be easily recognized. Thus, it is possible to determine an operation parameter of the manufacturing apparatuses 64a, 64b, . . . , 64n, which cause a failure in the workmanship.

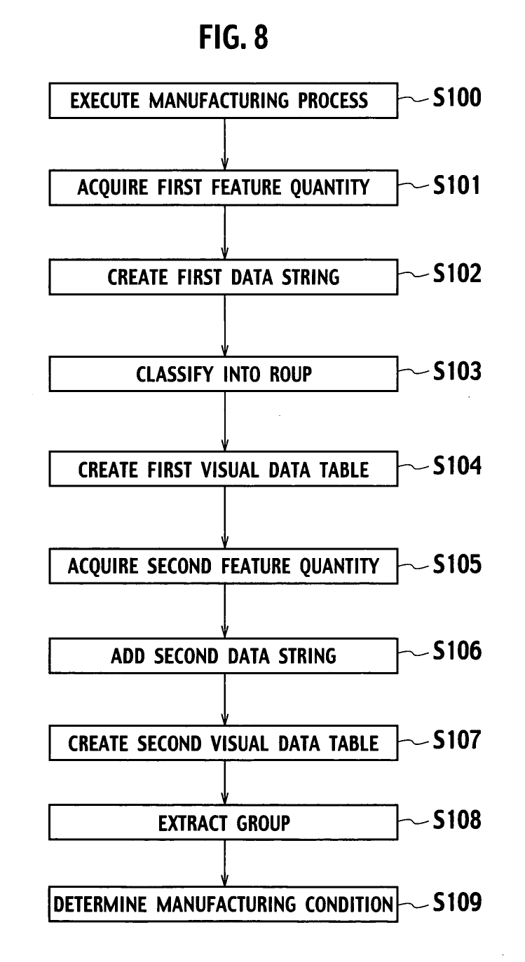

Next, a method for determining a failure of a manufacturing condition according to the embodiment of the present invention is described with reference to the flowchart shown in FIG. 8.

In step S100, manufacturing processes for the plurality of products are executed using the plurality of manufacturing apparatuses 64a, 64b, . . . , 64n shown in FIG. 1 under corresponding manufacturing conditions. During the manufacturing processes, operation parameters of the plurality of manufacturing apparatuses 64a, 64b, . . . , 64n, which correspond to manufacturing conditions, are monitored by the plurality of monitor units 66a, 66b, . . . , 66n and stored in the manufacturing information database 62, as the operation parameter data, through the manufacturing control system 60.

In step S101, the operation parameter data is acquired by the input module 32 of the visualization processing unit 30 from the manufacturing information database 62.

In step S102, the waveform creation module 34 creates first data string waveforms for each of the plurality of products from the first data strings having a string of values of the plurality of first characteristic variables PFa, PFb, PFc, PFd, and PFe corresponding to the operation parameter data.

In step S103, the classification module 36 classifies the first data strings that are analogous to one another into the plurality of groups Gr1 to Gr9, based on correlations between the first data string waveforms.

In step S104, for each of the plurality of groups Gr1 to Gr9, the table creation module 38 creates a first visualized data table which visualizes magnitude correlations of the plurality of first characteristic variables PFa, PFb, PFc, PFd, and PFe using a first graphic pattern.

The inspection tool 68 inspects and measures workmanship of the plurality of products, such as quality control characteristics after completion of each manufacturing process and electrical characteristics after completion of the entire manufacturing processes. The manufacturing control system 60 stores the workmanship data measured by the inspection tool 68 into the manufacturing information database 62.

In step S105, the input module 32 acquires a plurality of second characteristic variables RFa, RFb, RFc, RFd, and RFe, which correspond to the workmanship data, from the manufacturing information database 62.

In step S106, second data strings having strings of values of the plurality of second characteristic variables RFa, RFb, RFc, RFd, and RFe are added to the plurality of groups Gr1 to Gr9, respectively.

In step S107, table creation module 38 creates a second visualized data table which indicates magnitude correlations of the respective second characteristic variables RFa, RFb, RFc, RFd, and RFe in each of the plurality of groups Gr1 to Gr9, by a second graphic pattern.

In step. S108, based on the magnitude correlationships of a target second characteristic variable in the plurality of second characteristic variables RFa, RFb, RFc, RFd, and RFe, a target group which is a determination target for a failure of a manufacturing process, is extracted from the plurality of groups Gr1 to Gr9. A target first characteristic variable which is the cause of poor workmanship of the target group, is extracted from the first characteristic variables PFa, PFb, PFc, PFd, and PFe of the target group based on the magnitude correlations between the first characteristic variables by using the first visualized data table.

In step S109, based on a target operation parameter of the manufacturing apparatus corresponding to the extracted target first characteristic variable, measures to improve a manufacturing condition of the manufacturing process are determined.

Thus, after revising the manufacturing conditions corresponding to the operation parameters for the desired product quality, manufacturing processes are execute at the next production.

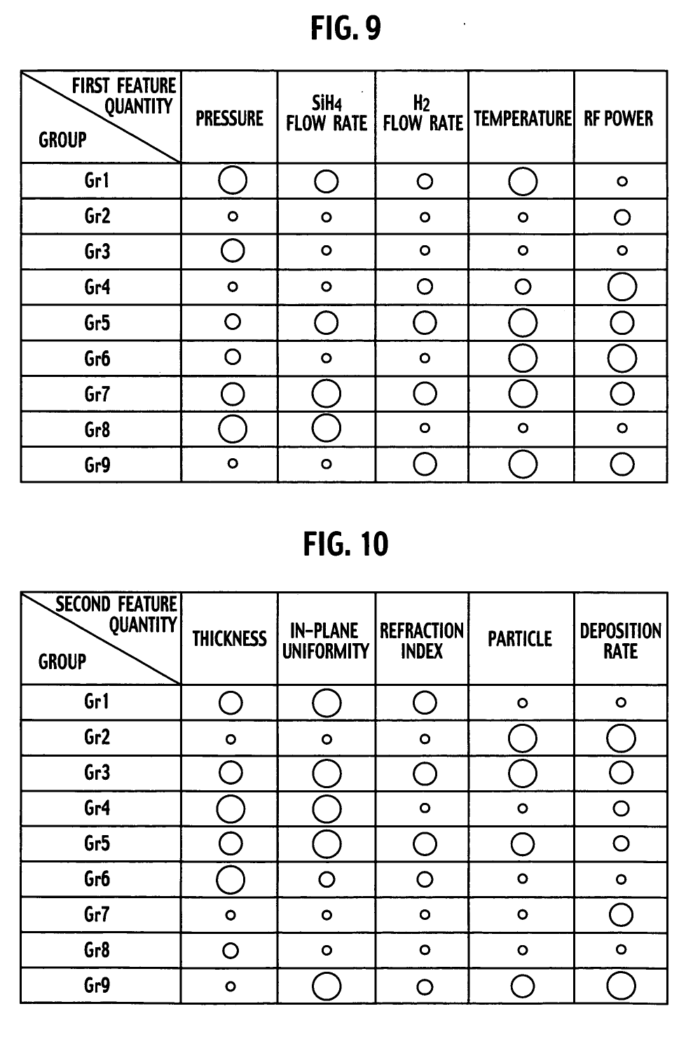

As a product example, during a deposition process of a semiconductor device, the pressure, the flow rate of silane gas (SiH₄), the flow rate of hydrogen (H₂), the wafer temperature, the RF power, and the like, in a CVD chamber are obtained as operation parameter data by a monitor unit of a CVD apparatus. As shown in FIG. 9, a first visualized data table is created for the groups Gr1 to Gr9 which are classified based on waveforms of the first characteristic variable data strings corresponding to the operation parameter data of the deposition process. In the first visualized data table, magnitude correlations between first characteristic variables are indicated by the size of graphic patterns.

After the deposition process, a quality control process is executed and the results (workmanship) of the deposition process are measured. A film thickness, an in-plane uniformity, a refraction index of a deposited film, a number of particles, a deposition rate, and the like, are measured as the workmanship data of the deposition process. Second characteristic variables corresponding to the measured workmanship data are classified into the groups Gr1 to Gr9 which correspond to the product numbers. Thereafter, as shown in FIG. 10, the second visualized data table, which indicates magnitude correlations between the second characteristic variables by the sizes of the graphic patterns, is created.

For example, when there is a problem in the deposition process such that the number of particles is large and the yield rate is decreased, the group, in which the large number of particles are detected, is extracted from the second visualized data table. As shown in FIG. 10, the graphic patterns indicate the number of particles is large in the groups Gr2 and Gr3. Thus, the groups Gr2 and Gr3 are visually recognized as the target groups for determining a failure of a manufacturing condition.

Next, it is visually easily recognized that, in the first visualized data table shown in FIG. 9, sizes of the graphic patterns for flow rates of SiH₄ and H₂, and temperature, of both the target groups Gr2 and Gr3 are smaller than other groups. As a result, it is determined that the number of particles increases under deposition conditions with low flow rates of SiH₄ and H₂, and low wafer temperature. It can be understood that increases in flow rates of SiH₄ and H₂ as well as in wafer temperature are useful measures to reduce the number of particles.

Furthermore, in order to obtain deposition conditions to achieve a small film thickness, a good in-plane uniformity, and a small number of particles, an group, in which sizes of graphic patterns for a film thickness, an in-plane uniformity, and the number of particles is small, are extracted from the second visualized data table. As shown in FIG. 10, the group Gr7 is visually recognized as the target group for determining a failure of a manufacturing condition. It is determined from the first visualized data table shown in FIG. 9 that the deposition process of the target group Gr7 has a high flow rate of SiH₄, a high wafer temperature, and average values of other first characteristic variables. Therefore, by adjusting set values of deposition conditions of the CVD apparatus, a deposition process for a small film thickness, a good in-plane uniformity and a small number of particles is achieved.

In the method for determining a failure of a manufacturing condition according to the embodiment of the present invention, a relation between the workmanship data and the operation parameter data of the manufacturing apparatuses is visually easily recognized. Thus, it is possible to determine a failure of a manufacturing condition which affects a yield rate of a manufacturing process.

### Other Embodiments

In the embodiment of the present invention, a manufacturing process of a semiconductor device is described as an example. However, it should be easily understood from the foregoing descriptions that the present invention can also be applied to manufacturing processes of industrial products such as automobiles, chemicals, building components, liquid crystal devices, magnetic recording mediums, optical recording mediums, thin film magnetic heads, superconductor devices, and the like.

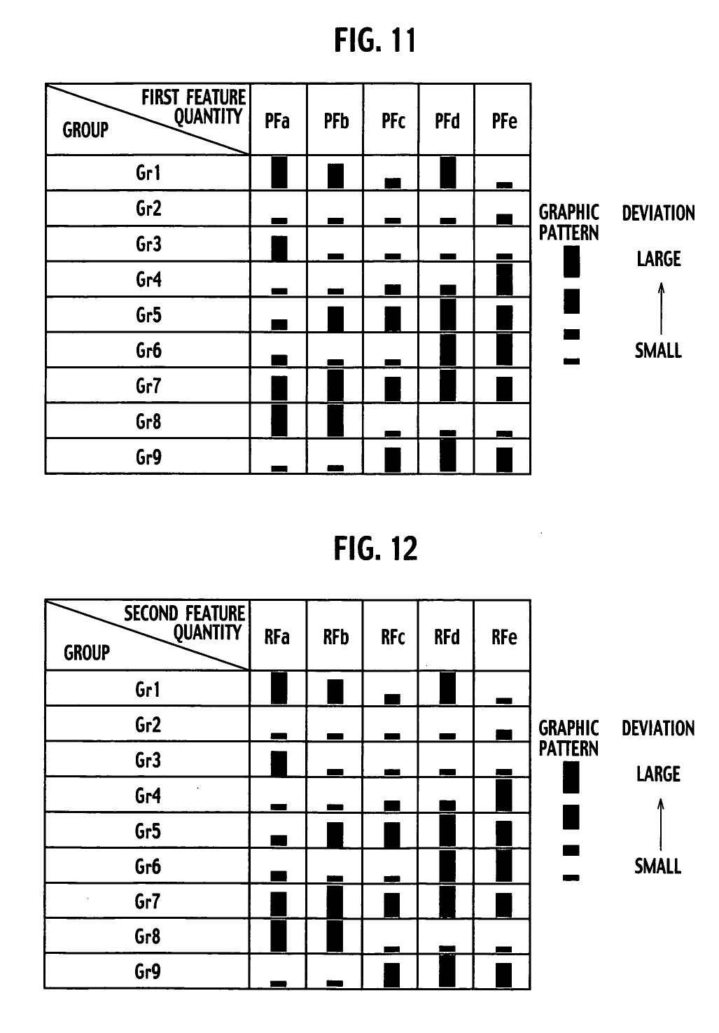

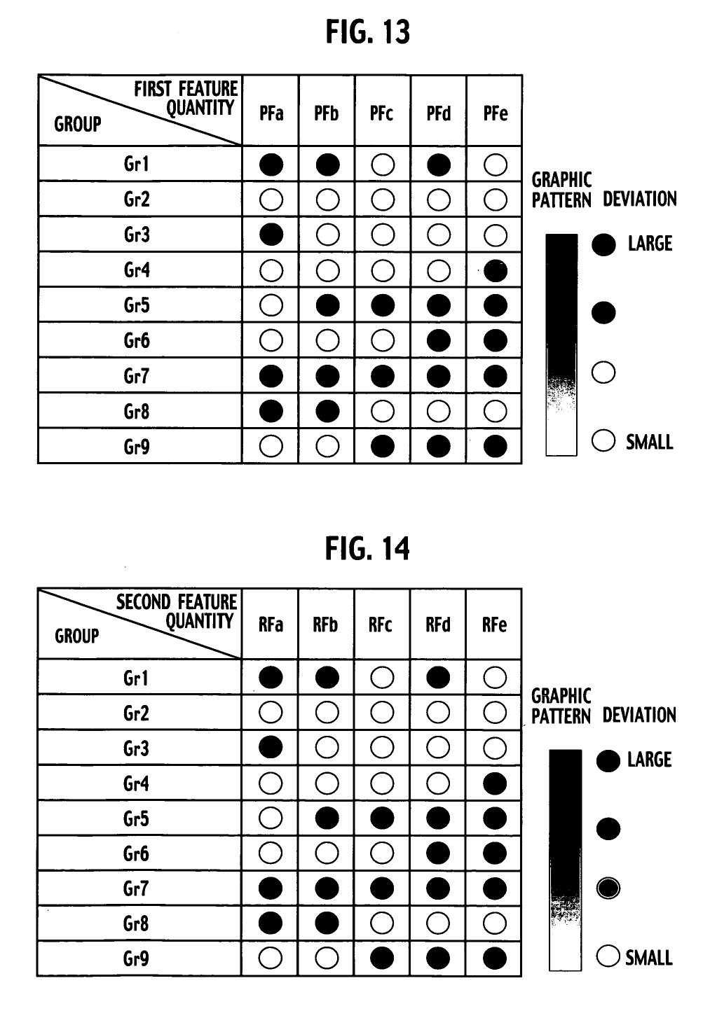

Additionally, in the embodiment of the present invention, circles are used as graphic patterns in the first and second visualized data tables. However, the graphic patterns are not limited to circles. For example, as shown in FIGS. 11 and 12, bars can be used as the graphic patterns in the first and second visualized data tables. The magnitude correlations between deviations of the first and the second characteristic variables are expressed by the lengths of the bars. Alternatively, as shown in FIGS. 13 and 14, a gray scale can be used as the graphic patterns of the first and second visualized data tables. The magnitude correlations between deviations of the first and second characteristic variables are expressed by different densities of the gray scale.

Various modifications will become possible for those skilled in the art after storing the teachings of the present disclosure without departing from the scope thereof.

What is claimed is:

1. A computer implemented method for determining a failure of a manufacturing condition, comprising:
creating a plurality of waveforms implemented by respective first data strings of first characteristic variables corresponding to operation parameter data of a plurality of manufacturing apparatuses which execute a plurality of manufacturing processes of a plurality of products under respective manufacturing conditions for the products;
classifying the first data strings that are analogous to each other into a plurality of groups based on a correlation of the waveforms;
creating a first visualized data table for each of the groups, the first visualized data table visualizing magnitude correlations between the first characteristic variables;
adding second data strings of second characteristic variables to the groups, the second characteristic variables corresponding to workmanship data representing measurement and inspection results of the products; and
creating a second visualized data table for each of the groups, the second visualized data table visualizing magnitude correlations between the second characteristic variables.

2. The method of claim 1, further comprising:
extracting a target group from the groups based on the magnitude correlations between a target second characteristic variable in the second characteristic variables by using the second visualized data table; and
extracting a target first characteristic variable from the first characteristic variables of the target group based on the magnitude correlations between the first characteristic variables by using the first visualized data table.

3. The method of claim 1, wherein the first characteristic variables are deviations from average values of the operation parameter data.

4. The method of claim 1, wherein the groups are classified based on a correlation coefficient for all combinations of the products.

5. The method of claim 1, wherein the first and second graphic patterns represent the magnitude correlations by one of sizes of circles, lengths of bars, and densities of gray scales.

6. The method of claim 1, wherein the operation parameter data include at least one of pressure, gas flow rate, wafer temperature, and input radio frequency power in at least one process chamber of the manufacturing apparatuses.

7. The method of claim 1, wherein the products are semiconductor devices.

8. The method of claim 7, wherein the workmanship data include quality control characteristics after completion of each of the manufacturing processes and electrical characteristics of the semiconductor devices.

9. A system for determining a failure of a manufacturing condition, comprising:
a plurality of monitor units configured to acquire operation parameter data of a plurality of manufacturing apparatuses which execute a plurality of manufacturing processes of a plurality of products under respective manufacturing conditions for the products;
an inspection tool configured to acquire workmanship data representing measurement and inspection results of the products;
a waveform creation module configured to create a plurality of waveforms implemented by first data strings of first characteristic variables corresponding to the operation parameter data for each of the products;
a classification module configured to classify the first data strings that are analogous to each other into a plurality of groups based on a correlation of the waveforms;
a table creation module configured to create a first visualized data table for each of the groups and a second visualized data table by adding second data strings of second characteristic variables corresponding to the workmanship data to the groups, the first visualized data table visualizing magnitude correlations between the first characteristic variables, the second visualized data table visualizing magnitude correlations between the second characteristic variables; and
an internal memory configured to store the operation parameter data, the workmanship data, the first and second data strings, the groups, and the first and second visualized data tables.

10. The system of claim 9, wherein the first characteristic variables are deviations from average values of the operation parameter data.

11. The system of claim 9, wherein the groups are classified based on a correlation coefficient for all combinations of the products.

12. The system of claim 9, wherein the first and second graphic patterns represent the magnitude correlations by one of sizes of circles, lengths of bars, and densities of gray scales.

13. The system of claim 9, wherein the operation parameter data include at least one of pressure, gas flow rate, wafer temperature, and input radio frequency power in at least one process chamber of the manufacturing apparatuses.

14. The system of claim 9, wherein the products are semiconductor devices.

15. The system of claim 14, wherein the workmanship data include quality control characteristics after completion of each of the manufacturing processes and electrical characteristics of the semiconductor devices.

16. A method for manufacturing an industrial product, comprising:
executing manufacturing processes of a plurality of products under respective manufacturing conditions for the products;
acquiring operation parameter data of a plurality of manufacturing apparatuses which execute the manufacturing processes, the operation parameter data corresponding to the manufacturing conditions;
creating a plurality of waveforms implemented by first data strings of first characteristic variables corresponding to the operation parameter data for each of the products;
classifying the first data strings that are analogous to each other into a plurality of groups based on a correlation of the waveforms;
creating a first visualized data table for each of the groups, the first visualized data table visualizing magnitude correlations between the first characteristic variables;
acquiring workmanship data representing measurement and inspection results of the products;
adding second data strings of second characteristic variables to the groups, the second characteristic variables corresponding to the workmanship data;
creating a second visualized data table for each of the groups, the second visualized data table visualizing magnitude correlations between the second characteristic variables;
extracting a target group from the groups based on the magnitude correlations between a target second characteristic variable in the second characteristic variables by using the second visualized data table;
extracting a target first characteristic variable from the first characteristic variables of the target group based on the magnitude correlations between the first characteristic variables by using the first visualized data table; and
executing a target manufacturing process by determining measures for a target manufacturing condition corresponding to the target first characteristic variable at the next production.

17. The manufacturing method of claim 16, wherein the first characteristic variables are deviations from average values of the operation parameter data.

18. The method of claim 16, wherein the groups are classified based on a correlation coefficient for all combinations of the products.

19. The method of claim 16, wherein the first and second graphic patterns represent the magnitude correlations by one of sizes of circles, lengths of bars, and densities of gray scales.

20. The method of claim 16, wherein the operation parameter data include at least one of pressure, gas flow rate, wafer temperature, and input radio frequency power in at least one process chamber of the manufacturing apparatuses.
